(19) United States
(12) Patent Application Publication
(10) Pub. No.: US 2014/0357226 A1
(43) Pub. Date: Dec. 4, 2014

(54) Zone Based Radio Communication System

(71) Applicant: Kent S. Charugundla, New York, NY (US)

(72) Inventor: Kent S. Charugundla, New York, NY (US)

(21) Appl. No.: 13/905,086

(22) Filed: May 29, 2013

(51) Int. Cl. H04W 4/02; H04W 4/08; H04W 12/06

(52) U.S. Cl. CPC H04W 4/023; H04W 12/06; H04W 4/08
USPC 455/411; 455/412.1; 455/418

(57) ABSTRACT

A geographic zone base (ZB) radio voice/text chat group communication system where users register to become subscribers of the communication system and join various zone based chat groups to become members of such groups. Any member can broadcast to all listening members of the chat group who, along with the member, are physically located within the geographic zone defined for the chat group. A chat group is created by a subscriber or by the communication system that operates and manages the chat groups. The communication system, in managing the chat groups, is coupled to a communication network (e.g., a cellular communication network) via the Internet and allow users of the cellular communication network to become members and participate in the ZB radio chat groups through the use of their cellular phones to transmit messages to the communication system via the Internet for broadcasting to their respective chat groups.

### FIELD OF THE INVENTION

The present invention generally relates to the field of telecommunications. In particular, the present invention relates to a geographic zone based voice/text chat group communication system and method thereof.

### BACKGROUND OF THE INVENTION

In today's technological environment, information is readily available through the use of many different types of portable communication devices (i.e., mobile devices) now commonly used by virtually everyone in our society. Smart phones, tablets, portable laptops and other such devices are ubiquitous and have become part of our everyday landscape. Surprisingly, the manner in which much of the information conveyed over communication networks (e.g., the Internet, cellular communication systems) with the use of these communication devices is lacking in the types of naturally occurring community communication needs that often exist in our society today.

In any society there is always a need for its members to communicate with each other in multiple contexts and circumstances. For example, there is always a need for people to communicate with each other at public gatherings, at specific locations or areas, at well-defined town centers, landmarks (or well known locations), zones, roads, and the locations of special or community-wide events. Prior to the advent of the Internet, there existed publicly accessible communication systems that allowed virtually anyone to use certain mobile devices to communicate with anyone else within a geographical zone in which both parties were located. Such systems included CB (Citizen's Band) radio, push to talk services and/or walkie talkies, which allowed for local voice/text communications within a geographically limited zone. Further, internationally linked groups have, for decades and still do today, used short wave radios to communicate with each other over great distances and across continents. Also, various amateur radio bands are still available to licensed users who communicate with each other over great distances.

Oftentimes in the context of geographic zone based communications, the aforementioned public communication systems were inadequate in that the available communication channels were crowded, the quality of the voice/text signals was often adversely affected by tall building and other physical structures that obstructed the lines of communication, and private communications between two parties or a select group were not available. Further, because the range of communications for these types of situations was severely limited, the instantaneous live reporting or instantaneous discussions between on-site individuals and off-site individuals was not available. With the coming of the Internet and cellular communications technology, many of these problems have been addressed to various extents, but there is still a need for voice/text communications in the context of geographic zones. The existence of the Internet and the voice and text chat services that the Internet provides have addressed, to a certain extent, the need for geographic zone based voice/text services. However, as useful as the Internet and cellular communications have been, the need for geographic zone based voice/text services has not been adequately addressed as local communities have evolved into a plethora of groups formed within the local communities and groups that span geographic, cultural, and religious boundaries.

### SUMMARY OF THE INVENTION

The present invention provides a communication system and method, which when coupled to one or more communication networks that provide voice/text communications services, provides users of the communication networks the ability to form geographic zone based radio voice/text chat groups (or “ZB radio voice/text chat groups”). A user is able to become a subscriber to the services provided by the communication system of the present invention by registering for such services, which includes entering into a subscription agreement with an owner/controlling entity of the communication system. A subscriber can then become a member of one or more ZB radio voice/text chat groups created by the communication system. The communication system also allows subscribers to create ZB radio voice/text chat groups; such subscribers are, by default, members of the groups that they have created. Members of a ZB radio voice/text chat group can then use their user equipment (e.g., cellular telephone) to broadcast messages, in push to talk fashion, to any and all group members who are listening (also with their user equipment) for messages and who are physically located in the geographic zone of the group during the broadcast. Conversely, members who have activated their user equipment (e.g., cellular telephone) and who are physically located within the geographic zone defined by a member of the group or the communication system of the present invention, are able to hear broadcasts from other members of the group. The communication system continuously monitors the physical location of all members to determine whether a member is physically within the geographic zone of the group; this is done with the use of user equipment geographic location data received by the communication system. The monitoring is done by the system at regular or irregular intervals and such intervals are defined by the communication system. The communication system also continuously monitors the identity of the user equipment of every member of a group to determine if that member is part of the group; this is done from the reception of user equipment identity data received by the communication system. Members of a group can be either on-site members or omnipresent members.

Members of a group who can broadcast and/or receive broadcasts of voice/text chats to/from a particular group only when they are physically located within the geographic boundaries (or zone) of the group as defined by the communication system of the present invention (or as defined by a member of that group), as on-site members. Members of a group who can broadcast and/or receive broadcast voice/text chats to/from a particular group regardless of their physical location are referred to as omnipresent members.

A subscriber who has become a member can broadcast voice/text messages in ‘push to talk’ fashion in much the same manner as CB radio, walkie-talkie users and users of other well-known public use communication systems. Any member of the group can, at any time, broadcast a voice/text message to all other members of the group who are listening at that particular time and who are physically located in the geographic zone (with the exception of omnipresent members). The system may provide or allocate a certain number of channels M, for each group where M is an integer equal to 1 or greater. That is, each group has at least one channel and depending on the population of the group, the system will allocate an appropriate number of channels for that group. Different channels may cover portions of the zone defined for that group or may cover the entire zone.

Still further, the communication system and method of the present invention allow peer-to-peer communications wherein two or more members after having exchanged identification data of their user equipment are able to communicate in push to talk fashion in relative privacy; thus a peer-to-peer chat group is not open to the general public and is not necessarily limited to a system defined geographic zone or a user defined geographic zone. Members of peer-to-peer groups may be required to enter unique identity codes (or passwords) before they are given access to such groups by the communication system of the present invention.

The communication system of the present invention can be used as a stand-alone communication system for ZB-radio voice/text chat groups or can be used as an added feature for already existing communication networks such as cellular communication networks and/or the Internet or a combination thereof. As a standalone system, it can provide ZB radio voice/text chat services to users who have subscribed to such services and who possess the proper user equipment (i.e., mobile communication devices) to communicate with the communication system and other users of the communication system through the ZB radio voice/text chat groups established by the system or by members of the system.

In one embodiment of the communication system of the present invention, the communication system is coupled to one or more communication networks to provide ZB radio voice/text chat service to one or more of such communication networks. For ease of explanation, the discussion that follows discusses the communication system of the present invention coupled to the Internet and a cellular communication network; this is one implementation of how the communication system can be used or applied. This implementation does, in no way, limit the use of the communication system to this particular embodiment.

The communication system of the present invention comprises a Management Server in communication with at least one communication network; a Database Server in communication with the Management Server where the Database Server contains data comprising either one or both of geographic location data and user equipment identity data for all subscribers to the communication system. The Database server 104 also contains user profile information and user authentication information. The communication system further comprises a Voice/Text Chat Server in communication with and controlled by the Management Server to broadcast voice/text communications from any member of a ZB radio voice/text chat group to any and all listening members (on-site and/or omnipresent) of that group.

The Voice/text Chat Server allows any and all members of a voice/text chat group to operate their user equipment (i.e., a communication device such as a cellular telephone) in push to talk fashion based on an app (application software) downloaded onto the user equipment directly from the Voice/text Chat Server or indirectly from the Voice/text Chat Server via equipment of the one or more communication networks coupled to the communication system of the present invention. The downloaded app allows the user's equipment to be used as a push to talk device by a member of a group. The Management Server receives every broadcast of any member of any group at all times. Upon reception of a broadcast message, the Management Server determines the identity of the user equipment and thus the identity of the member in control of the user equipment. To further confirm the identity of the member, the Management Server may require the member to input a password before the member is allowed to broadcast messages. The Management Server is able to verify the password entered by the member and thus the identity of the member from user authentication information and user profile information that are stored in the Database server and which was entered by the user during a registration process established by the communication system for new subscribers or for already registered members who wish to amend some or all of their user profile information, user authentication information, or user equipment identity information. The Management Server uses the latest user equipment geographic location data it has received to determine the current location of any member wishing to broadcast messages.

Upon confirmation of the member's identity, location and registration status, the Management Server will transfer messages from a member to the Voice/Text Chat Server and signals the Voice/Text Chat Server to assign a communication port to the message and at the opportune time to transmit the messages to a list of members defined by the Management Server. The list of members are the members of a ZB radio voice/text chat group who are listening for messages within the appropriate zone and who belong to the same voice/text chat group as the broadcaster.

The method of the present invention as performed by a user equipment (due to the app downloaded onto the user equipment) allows users (i.e., prospective members) to register for ZB radio voice/text chat service at communication portals defined and provided by the communication system of the present invention. Examples of communication portals are publicly accessible websites and/or phone numbers that prospective members can access or call respectively to register for ZB radio voice/text chat service and to enter into a subscription agreement with the entity that owns and/or operates the communication system. As described above, the communication system of the present invention is often coupled to one or more communication networks (e.g., cellular communication network and/or the Internet) that provide voice/text communication services. The entity that owns and/or operates the communication networks may be the same entity that is providing cellular service and/or Internet service to the prospective subscriber. At the communication portals, potential subscribers enter user profile information, user authentication information, user equipment identification information and any other pertinent information to the communication system and enter into a subscription agreement with the owner/controlling entity of the communication system.

Once registered, the subscriber is given the opportunity to join an existing chat group or peer-to-peer group or create a new chat group. That is, a prospective subscriber is given the opportunity to (i) become an on-site member of one or more existing system created ZB Radio voice/text chat groups; (ii) become an omnipresent member of one or more existing system created ZB radio voice/text chat groups; (iii) become an on-site member of one or more user created ZB radio voice/text chat groups; (iv) become an omnipresent member of one or more user created ZB radio voice/text chat groups; (v) create a peer-to-peer ZB radio voice/text chat group or join an already existing peer-to-peer ZB radio voice/text chat group. In all cases, especially in the case of peer-to-peer groups, the prospective member will need to provide user equipment identity information to allow the communication system to confirm the eligibility of this equipment to gain access to private peer-to-peer groups.

The Management Server receives various requests from the communication portals through which users desiring to become members of chat groups or users desiring to register for membership to the communication system make their requests. Also, already registered users may sometimes desire to amend their user profile information or user authentication information or user equipment identity information. The Management Server monitors the operation of the Voice/Text Chat Server during ZB radio voice/text chat operation. The Management Server will analyze the voice/text messages generated in the chat groups to make sure that all the voice/text messages to be broadcast by the communication system are actually from properly registered subscribers and broadcast in the correct ZB radio voice/text chat groups. This is to avoid circumstances where users of communication devices associated with the one or more communication networks coupled to the communication system of the present invention have downloaded the proper app for their devices, but have not registered at all for the ZB radio voice/text chat service being provided by their communication provider. Once the Management Server confirms that a voice/text message intended to be broadcast to a ZB radio chat group is from a registered subscriber, the Management Server causes the Voice/Text Chat server to activate its communication ports resulting in the broadcast of the message to any and all members of the chat group located within the physical zone of the chat group and to omnipresent members of the group.

After a user has properly registered and has properly become a member of one or more voice/text chat groups, such a member can broadcast messages in push to talk manner at any available time. All broadcast voice/text messages are first received by the Management Server which identifies the member and the various data associated with the member from the member's user profile information, user authentication information, user equipment identity information, the group(s) to which the member belongs and the current geographic location of the member; all of this information is stored in the Database Server and is accessible to the Management Server. If the received message is not from a member who is a registered subscriber, the Management server sends an appropriate message (in text form, for example) informing the user that he/she is not recognized as a member and directs the user to a communication portals where the user can register to become a subscriber and a member of one or more groups.

When the message received by the Management server is a broadcast message from a verifiable member who can broadcast at the time of the message reception, the Management Server transfers the message to the Voice/Text Chat Server and instructs the Voice/Text Chat Server to Broadcast the message as per a protocol established by the ZB radio communication system. The Management Server also receives request messages from new or existing members desiring to join or create a new chat group. In such a case, the Management server processes the subscriber's desire to create or join an already existing chat group. If a subscriber or member wishes to create a new chat group that is not permissible, the Management Server sends an appropriate message to the member and provides several alternatives such as create a chat group with acceptable parameters, or join an already existing group that meets the member's parameters. A newly created chat group will operate in the same manner as the existing chat groups. The Management Server continues to look for messages and also manages on-going chat sessions of the communication system.

### BRIEF DESCRIPTION OF THE DRAWINGS

The features and advantages of the present invention will become more apparent from the detailed description set forth below when taken in conjunction with the drawings in which like reference numbers indicate identical or functionally similar elements.

FIG. 1 is a system block diagram depicting the Zone Based radio voice/text chat communication of the present invention coupled to a cellular communication network and the Internet.

FIG. 2 shows the different types of chat groups available to a subscriber of the communication system of the present invention.

FIG. 3 is a flow chart of a method of conveying voice/text communication signals to a zone based chat group by a user equipment.

FIG. 4 is a flow chart of the method of conveying voice/text communication signals zone based chat group by the communication system of the present invention.

FIG. 5 shows one example of a user equipment and the type of information displayed by such equipment during operation in a chat group.

### DETAILED DESCRIPTION

The description of the communication subsystem and the method of selecting features of the present invention is disclosed herein using the following terms, terminology, definitions and abbreviations:

The term “automatic” or “automatically” refers to a process of steps and/or act(s) performed by electrical, electronic or electromechanical devices, mechanical devices, machines or systems (including the communication system of the present invention) in response to information inputted into such machines, devices or systems.

The communication network is any digital or analog network or any combination of such networks whereby transmission and reception of associated text, voice/text, video, and graphics can be achieved.

An owner/controlling entity of the communication system is able to completely operate and/or control the operation of the equipment in any appropriate manner as deemed warranted by such entity or its agent. A legal entity such as a person or a corporation or any defined entity can own the equipment or control the equipment at any time or only during certain time periods.

User profile information (inputted by a subscriber) is identification information and relevant personal information of a subscriber. The inputting of information is mostly implemented with GUI (Graphical User Interface) interfaces that are used to prompt a registering user to input particular profile information. The profile information may include information that is unique to the subscriber to allow a Management server of the communication system to authenticate the subscriber at a later time. Examples of user profile information include a user's name, email address, phone number, cell phone number, and a MAC (Media Access Control) address.

The term user refers to any entity (i.e., person, legal entity) capable of subscribing to the services being provided by the communication system of the present invention. A user selects the features from available set of features for voice and/or text services being provided by the communication system of the present invention. Also a person or entity who is using the services of the communication system via one or more communication networks accessible to that person or entity. A user may be a person who has not completed registration or a person who has not registered at all.

The term subscriber refers to a user who has provided personal information, user profile information and user authentication information in response to prompts and queries from the communication system during registration. A subscriber is a registered user. A user is given the opportunity to input additional appropriate information related to the types of services for which he/she desires.

A member is a subscriber who has joined a chat group based on certain requirements set by the group and/or the communication system of the present invention. The requirement may be that the subscriber has actually registered into the communication system of the present invention and as such is sufficient to become a member of a group. Different chat groups have different requirement for a subscriber to become a member.

User authentication information of a subscriber confirms the identity of a registered subscriber. The authentication is the act precedent to giving a registered subscriber or a user access to the communication system based on at least some of the user\profile information inputted during the registration process (or at a later time) of the registered subscriber or potential subscriber (i.e. a user). In addition to profile information, unique information (e.g., password, answers to specific personal questions), of the user or registered subscriber is typically used to allow the communication system to provide access to a registered subscriber and provide agreed upon services to the registered subscriber.

User equipment identity information refers to data that uniquely identify a user equipment (e.g., a cellular telephone). Such data is usually assigned to the equipment by the manufacturer of the user equipment and by identity mechanisms used to identify equipment in various communication network. For example, for a cellular communication network, the cellular telephone serial number, the pin number of the cellular telephone and the IMEI (International Mobile Equipment Identity) of the cellular telephone number and the MAC (Media Access Control) address associated with the cellular phone can be used to uniquely identify the user equipment.

User equipment geographic location data refers to information that describe and/or specify the geographic location of a user equipment once activated and executing an app downloaded thereon to participate in ZB radio voice/text or text chat groups. Examples of such information include information and triangulation information of a cellular phone or any device having the ability to receive such information.

A Member is a person or entity (i.e., a registered subscriber) who has registered into the communication system and has joined a zone based voice/text or text chat group. A member has met the requirements for membership based on its user profile information and any other information deemed important by the leader of the chat group to which the member has joined.

A Server is a computer or computer system comprising of one or more processors, various blocks of memory, and supporting circuitry to process information and to interface with users or other servers.

An App refers to a downloadable executable program containing instructions to perform steps giving a user equipment the ability to broadcast chat messages and exchange information with the communication system of the present invention to allow, inter alia, creation of new chat groups, gathering user information during registration (or registration amendments), and causing the user equipment to display various items during chat sessions.

The term “couple” or “couple(d) to” as used herein refers to a path or a series of connected paths (permanent or temporary) that allows information (in one or more formats) or signals to flow from one point or equipment in a communication network to another point within the same equipment or another equipment in the same or different communication network in accordance with the protocol(s) of the communication network(s).

Push to talk operation refers to a manner of broadcasting voice/text signals using a user equipment. A subscriber depresses/touches the ‘push to talk’ button/graphic and has a set time within which he/she has to begin broadcasting. Immediately after touching/depressing a push to talk button/graphic, the subscriber receives a preamble burst tone from the communication system signaling the subscriber to start talking or texting. When no burst tone is received by the subscriber (i.e., the subscriber equipment), the subscriber has not been given the permission to start broadcasting and should wait; there will be a time out countdown of 1 seconds after which if there is still no tone burst, the subscriber is instructed to try again. Upon having reached the end of his/her broadcast, the subscriber can either stop talking allowing the system to time out and end the broadcast or the subscriber can push/touch an end of broadcast button/graphic to signal the communication system that he/she has finished talking. The length of the broadcast is set by the communication system, but the subscriber can demand longer broadcast time, which may or may not be given by the system.

A communication portal refers to a user accessible communication access point to/from which users convey (i.e., transmit and/or receive) information regarding the type of service they desire or to register into a communication system. The communication portal can be part of the communication system or be coupled to equipment of the communication system. The communication portal can be part of another network that is in communication with the communication system. The portal can be a website on the Internet or a phone number serviced by agents of the communication system or service provider

ZB radio voice/text chat group refers to a geographic zone base group created by the communication system or by a registered subscriber of the communication system that allows any member of the group to broadcast to other listening members who are physically located in the geographical zone as defined by the creator of the group. The group may be formed based on a general theme or a particular common interest of its members; the group may also be formed due to its location and the interest in that location by its members. Voice can be converted to text or text can be converted to synthesized voice and the resulting signal is then broadcast.

Internet enabled devices are devices such as laptops, telephones, cellular phones (e.g., smart phones), tablets, desktop computers and other communication devices capable of gaining access to the Internet through the use of Internet browsers such as Explorer, Safari, Firefox, Windows Mobile, Netscape Navigator, Lynx, Symbian, and receive information not only in their original formats, but also in Java, Flash, HTTP/S, TEXT and XML formats which are typically used by the Internet and Internet enabled devices.

The term voice/text chat refers to the service provided by the communication system of the present invention where broadcasts are made with voice messages, text messages or a combination of voice and text messages. In situations where voice communications is lacking in quality a user can switch to text or synthesized voice (text message is applied to a voice synthesizer resulting in the text being converted to an automated voice operation) operation. Alternatively a user can voluntarily select voice or text or can set its user equipment to automatically switch from voice operation to text operation in circumstances where voice communications are not available or are not operating at acceptable (as defined by the user or communication system) levels.

The term messages refers to voice/text messages.

The present invention provides a communication system and method, which when coupled to one or more communication networks that provide voice/text communications services, provides users of the communication networks the ability to form geographic zone based radio voice/text chat groups (or “ZB radio voice/text chat groups”). A user is able to become a subscriber to the services provided by the communication system of the present invention by registering for such services, which includes entering into a subscription agreement with an owner/controlling entity of the communication system. A subscriber can then become a member of one or more ZB radio voice/text chat groups created by the communication system. The communication system also allows subscribers to create ZB radio voice/text chat groups; such subscribers are, by default, members of the groups that they have created. Members of a ZB radio voice/text chat group can then use their user equipment (e.g., cellular telephone) to broadcast messages, in push to talk fashion, to any and all group members who are listening or checking for (with their user equipment) for voice/text messages and who are physically located in the geographic zone of the group during the broadcast. Conversely, members who have activated their user equipment (e.g., cellular telephone) and who are physically located within the geographic zone defined by a member of the group or the communication system of the present invention, are able to hear voice broadcasts or read text broadcasts from other members of the group. The communication system continuously monitors during intervals the physical location of all members (i.e., location of their user equipment) to determine whether a member is physically within the geographic zone of the group; this is done with the use of user equipment geographic location data received by the communication system. The monitoring is done by the system at regular or irregular intervals and such intervals are defined by the communication system. The communication system also continuously monitors the identity of the user equipment of every subscriber of a group to determine if that subscriber is a member and thus part of the group; this is done from the reception of user equipment identity data received by the communication system. Members of a group can be either on-site members or omnipresent members.

Members of a group who can broadcast and/or receive broadcasts of voice/text chats to/from a particular group only when they are physically located within the geographic boundaries (or zone) of the group as defined by the communication system of the present invention (or as defined by a member of that group), are referred to as on-site members. Members of a group who can broadcast and/or receive broadcast voice/text chats to/from a particular group regardless of their physical location are referred to as omnipresent members.

A subscriber who has become a member can broadcast voice/text messages in ‘push to talk’ fashion in much the same manner as CB radio, walkie-talkie users and users of other well-known public use communication systems. Any member of the group can, at any time, broadcast a voice/text message to all other members of the group who are listening at that particular time and who are physically located in the geographic zone (with the exception of omnipresent members). The communication system may provide or allocate a certain number of channels M, for each group where M is an integer equal to 1 or greater. That is, each group has at least one channel and depending on the population of the group, the system will allocate an appropriate number of channels for that group. Different channels may cover portions of the zone defined for that group or may cover the entire zone, but comprise different members. A channel is a system defined subgroup within the entire set of users who are members of the chat group.

Still further, the communication system and method of the present invention allows peer-to-peer communications wherein two or more members after having exchanged user equipment identity information are able to communicate in push to talk fashion in relative privacy; thus a peer-to-peer chat group is not open to the general public and is not necessarily limited to a system defined geographic zone or a user defined geographic zone. Members of peer-to-peer groups may be required to enter unique identity codes (or passwords) before they are given access to such groups by the communication system of the present invention.

The communication system of the present invention can be used as a stand-alone communication system for ZB radio voice/text chat groups or can be used as an added feature for already existing communication networks such as cellular communication networks and/or the Internet or a combination thereof. As a standalone system, it can provide ZB radio voice/text chat services to users who have subscribed to such services and who possess the proper user equipment (e.g., mobile communication devices such as laptops and cellular phones) to communicate with the communication system and other users of the communication system through the ZB radio voice/text chat groups established by the system or, with the permission of the system, by members of the system.

In one embodiment of the communication system of the present invention, the communication system is coupled to one or more communication networks to provide ZB radio voice/text chat service to one or more of such communication networks. For ease of explanation, the discussion that follows discusses the communication system of the present invention coupled to the Internet and a cellular communication network; this is one implementation of how the communication system can be used or applied. This implementation does, in no way, limit the use of the communication system to this particular embodiment.

The communication system of the present invention comprises a Management Server in communication with at least one communication network; a Database Server in communication with the Management Server where the Database Server contains information comprising either one or both of user equipment geographic location information and user equipment identity information for all subscribers to the communication system. The Database server 104 also contains user profile information and user authentication information. The communication system further comprises a Voice/Text Chat Server in communication with and controlled by the Management Server to broadcast voice/text communications from any member of a ZB radio voice/text chat group to any and all listening members (on-site and/or omnipresent) of that group.

The Voice/Text Chat Server allows any and all members of a voice/text chat group to operate their user equipment (i.e., a communication device such as a cellular telephone) in ‘push to talk’ fashion based on an app (application software) downloaded onto the user equipment directly from the Voice/Text Chat Server or indirectly from the Voice/Text Chat Server via equipment of the one or more communication networks coupled to the communication system of the present invention. The downloaded app allows the user's equipment to be used as a push to talk device by a member of a group. The Management Server receives every broadcast of any member of any group at all times. Upon reception of a broadcast message, the Management Server determines the identity of the user equipment and thus, supposedly, the identity of the member in control of the user equipment. To further confirm the identity of the member, the Management Server may require the member to input a password before the member is allowed to broadcast messages. The Management Server is able to verify the password entered by the member and thus the identity of the member from user authentication information and user profile information that are stored in the Database server and which was entered by the user during a registration process established by the communication system for new subscribers or for already registered members who wish to amend some or all of their user profile information, user authentication information, or user equipment identity information. The Management Server uses the latest user equipment geographic location data it has received (e.g., GPS coordinates from the user equipment) to determine the current location of any member wishing to broadcast messages.

Upon confirmation of the member's identity, location and registration status, the Management Server will transfer messages from a member to the Voice/Text Chat Server and instructs the Voice/Text Chat Server to assign a communication port to the message and at the opportune time to transmit the message to a list of members defined by the Management Server. The list of members are the members of a ZB radio voice/text chat group who are listening for messages within the appropriate zone and who belong to the same voice/text chat group as the broadcasting member.

The method of the present invention as performed by a user equipment (due to the app downloaded onto the user equipment) allows users (i.e., prospective members) to register for ZB radio voice/text chat service at communication portals defined and provided by the communication system of the present invention. Examples of communication portals are publicly accessible websites and/or phone numbers that prospective members can access or call respectively to register for ZB radio voice/text chat service and to enter into a subscription agreement with the entity that owns or controls and/or operates the communication system. As described above, the communication system of the present invention is often coupled to one or more communication networks (e.g., cellular communication network and/or the Internet) that provide voice/text communication services. The entity that owns and/or operates the communication networks may be the same entity that is providing cellular service and/or Internet service to the prospective subscriber. At the communication portals, potential subscribers enter user profile information, user authentication information, user equipment identification information, any other pertinent information to the communication system and enter into a subscription agreement with the owner/controlling entity of the communication system.

Once registered, the subscriber is given the opportunity to join an existing chat group or a peer-to-peer group or create a new chat group. That is, a prospective subscriber is given the opportunity to (i) become an on-site member of one or more existing system created ZB Radio voice/text chat groups; (ii) become an omnipresent member of one or more existing system created ZB radio voice/text chat groups; (iii) become an on-site member of one or more user created ZB radio voice/text chat groups; (iv) become an omnipresent member of one or more user created ZB radio voice/text chat groups; (v) create a peer-to-peer ZB radio voice/text chat group or join an already existing peer-to-peer ZB Radio voice/text chat group. In all cases, especially in the case of peer-to-peer groups, the prospective member will need to provide user equipment identity information to allow the communication system to confirm the eligibility of this equipment and gain access to private peer-to-peer groups and other groups requiring such information.

The Management Server receives various requests from the communication portals through which users desiring to become members of chat groups or users desiring to register for membership to the communication system make their requests. Also, already registered users may sometimes desire to amend their user profile information or user authentication information or user equipment identity information. The Management Server monitors the operation of the Voice/Text Chat Server during ZB radio voice/text chat operation. The Management Server will analyze the voice/text messages generated in the chat groups to make sure that all the voice/text messages to be broadcast by the communication system are actually from properly registered subscribers and are broadcast in the correct ZB radio voice/text chat groups. This is to avoid circumstances where users of communication devices associated with the one or more communication networks coupled to the communication system of the present invention have downloaded the proper app onto their devices, but have not registered at all for the ZB Radio voice/text chat service being provided by their communication provider. Once the Management Server confirms that a voice/text message intended to be broadcast to a ZB Radio chat group is from a registered subscriber, the Management Server causes the Voice/Text Chat server to activate its communication ports resulting in the broadcast of the message to any and all members of the chat group located within the physical zone of the chat group and to omnipresent (not necessarily physically located in the zone) members of the group.

After a user has properly registered and has properly become a member of one or more voice/text chat groups, such a member can broadcast messages in push to talk manner at any available time. All broadcast voice/text messages are received by the Management Server, which identifies the member and the various data associated with the member from the member's user profile information, user authentication information, user equipment identity information, the group(s) to which the member belongs and the current geographic location of the member; all of this information is stored in the Database Server and is accessible to the Management Server. If the received message is not from a member who is a registered subscriber, the Management server sends an appropriate message (preferably in text form) informing the user that he/she is not recognized as a member and directs the user to a communication portals where the user can register to become a subscriber and a member of one or more groups.

When the message received by the Management server is a broadcast message from a verifiable member who can broadcast at the time of the message reception, the Management Server transfers the message to the Voice/Text Chat Server and instructs the Voice/Text Chat Server to Broadcast the message as per a protocol adopted and/or established by the ZB radio communication system. The Management Server also receives request messages (preferably in text form) from new or existing members desiring to join or create a new chat group. In such a case, the Management server processes the subscriber's desire to create or join an already existing chat group. If a subscriber or member wishes to create a new chat group that is not permissible, the Management Server sends an appropriate message to the member and provides several alternatives such as create a chat group with acceptable parameters, or join an already existing group that meets the member's parameters. An impermissible chat group is one that violates the rules and policies of the communication system. A newly created chat group will operate in the same manner as the existing chat groups. The Management Server continues to look for messages and also manages on-going chat sessions of the communication system.

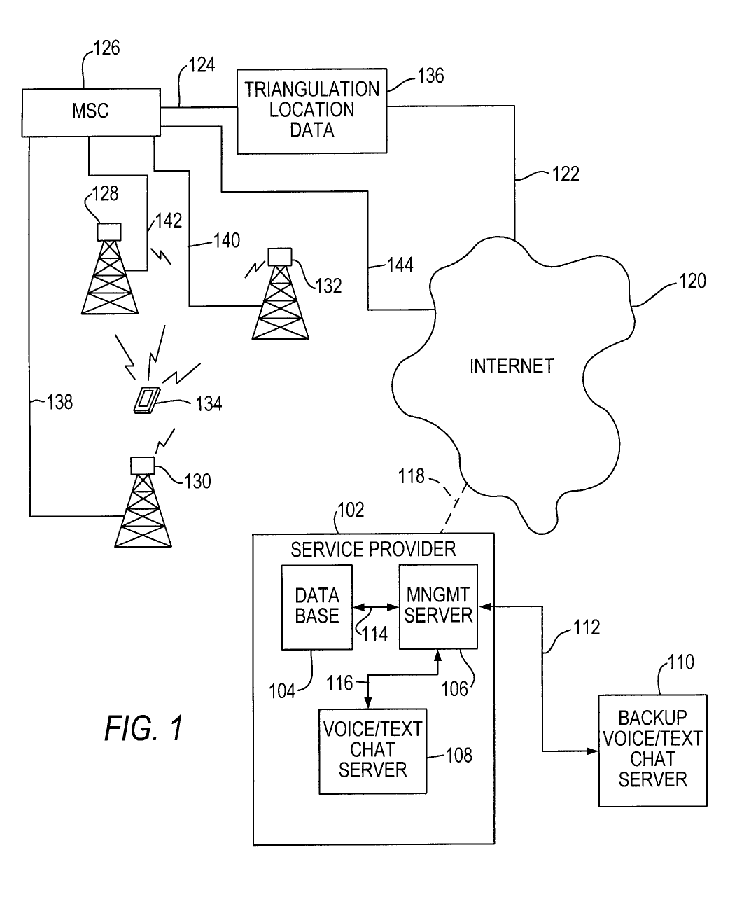

Referring now to FIG. 1, there is shown one embodiment of the communication system 102 of the present invention. For the sake of explanation, the communication system 102 of the present invention is shown directly coupled to the Internet 120 and indirectly coupled to a cellular communication network (via the Internet) whose components (or at least some of them) are shown in FIG. 1. It should be understood that the communication system 102 can be used as a stand alone system with the capability of obtaining user equipment geographic location information and/or GPS or triangulation data through other various well known means. The portion of the cellular communication network that is shown comprises three (3) cell sites 128, 130 and 132 connected to Message Switching Center (MSC) 126 via high bandwidth communication links 142, 138 and 140 respectively. MSC 126 is shown also connected to triangulation location database 136 via communication link 124. The MSC 126 is further shown connected to the Internet 120 via communication link 144. The Triangulation database 136 is also connected to the Internet 120 via communication link 122. A user equipment 134 (e.g., a cellular phone) is shown located at some point in the cellular communication network. The MSC 126 serves as the controller for the cellular communication networks; it receives signaling information and various other information about the information being conveyed (i.e., transmitted and/or received) by the cell sites to each other or to user equipment. The MSC 126 sends appropriate commands and/or instructions to the cell sites to ensure proper operation of the cellular communication network.

For the sake of explanation, say that the user equipment 134 is a ‘smart’ cellular phone with the capability of receiving GPS (Global Positioning System) signals from strategically located earth-orbiting satellites. Thus, mobile user equipment 134 is able to transmit its GPS data to the MSC; this information can then be transmitted to communication system 102, which stores it in Database 104. Triangulation Location Data database 136 can also calculate the geographic location information for user equipment 134 with the use of GPS location data or known location data of the cell sites 128, 130 and 132 to determine the geographic location of the mobile user equipment 134 using the well known technique commonly referred to as triangulation. The triangulation location database contains the geographic locations of the three or more cell sites with which a user equipment (such as user equipment 134) is communicating. By knowing the location of the cell sites (128, 130, and 132), the cellular communication network is able to estimate the physical location of the user equipment 134 through triangulation. The estimate of the physical location of the user equipment and the data (location of cell sites) used to calculate the location through triangulation is referred to as the triangulation information. In some cases, the triangulation information is used in combination with GPS information for a particular user equipment to determine a more precise geographical location of the user equipment. In sum, the location of a user equipment of a subscriber to the communication system of the present invention can be calculated from GPS information, triangulation information or a combination of both. Thus, the cellular communication network as shown is able to gather geographic location data of the user equipment 134 as often as it needs to do so. Broadcast voice/text messages transmitted and received by communication system 102 to and from user equipment 134 pass through the Internet 120 and are received by the communication system 102 via communication link 118. Communication link 118 is shown in dashed lines to differentiate it from the other communication links. Communication link 118 carries voice/text chat communications and messages conveyed (transmitted and/or received) between Management Server 106 and user equipment 134. The actual broadcasting of messages is done by the voice/text chat server 108 as discussed infra.

In the particular example shown, communication system 102 is coupled directly to the Internet 120, which is coupled to a cellular communication network comprising at least the cell sites (128, 130, and 132), MSC 126 and Triangulation Location Data database 136. Messages from user equipment 134 can either be chat broadcast messages or messages from a user wishing to amend hi/her registration information or information from a new subscriber in the process of registering. The new subscribers enter information during the registration process at a communication portal that can be part of Management Server 106 or a website on the Internet capable of sending the information entered by users over the Internet to Management Server 106. The Management server 106 transfers the information entered by a user to Database Server 104 via communication link 114. Also, the same communication link 114 is used by Management Server 106 to retrieve information from Database Server 104. Management Server 106 is also connected to Voice/Text Chat Server 108 via communication link 116 and Backup Voice/text Chat Server 110 via communication link 112. The Voice/Text Chat Servers 108 and 110 contain transmission and reception equipment to transmit and/or receive communication signals to/from the user equipment 134 directly or indirectly via the Internet and the cellular communication network shown in FIG. 1. Backup Voice/text Chat Server 110 carries duplicate information of Voice/Text Chat server 108 and is able to seamlessly replace Voice/Text chat server 108 in case of a failure.

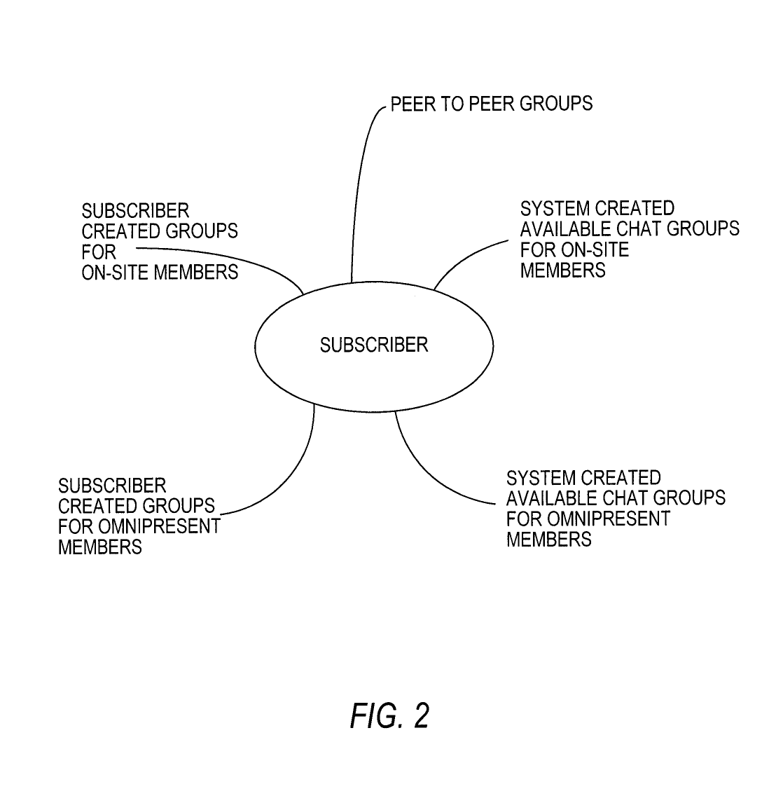

Referring now to FIG. 2, there is shown the various types of chat groups a subscriber can join and/or create upon registering to the communication system of the present invention. After having subscribed and accepted as a subscriber by the communication system, the subscriber is given the opportunity to create and/or join available chat groups. The subscriber is also given the opportunity to create or join peer-to-peer groups. Even further, for each group that the subscriber joins, he/she can be an on-site member or an omnipresent member. An on-site member is a member who, as long as he/she is physically located within the geographic zone or boundaries of a group, can broadcast to other members of the group and/or receive broadcasts from other members of the group in push-to-talk fashion. An omnipresent member of a group can broadcast and can receive broadcasts regardless of his/her physical location.

ZB Radio Chat Group Types

1. Peer-to-Peer Groups

Peer-to-peer groups do not include geographic zone or location as part of the definition of the group. Peer-to-peer groups are private voice/text chat groups created by a subscriber in cooperation with other subscribers who wish to join the group based on some arbitrary requirements set by the initial two members of the group or a founder of the group. Membership requirements may also be set by a member nominated by members of the group to be the spokesperson for the group. The existence of the group is not published or displayed by the communication system. Subscribers become members of the group when they have provided their unique user equipment identity information to the group organizer and to the Management Server 106 of the communication system of the present invention. Subscribers would know about the group presumably from another subscriber who is already a member of the group and has invited a new subscriber to join the group. The user equipment identity information are data unique to the user equipment; this data is typically generated by the manufacturer of the user equipment. The user equipment data may also include unique data assigned to the user equipment by the communication network within which the user equipment operates. For example, in a cellular communication network where the user equipment is a cellular telephone, examples of user equipment data are the IMEI (International Mobile Equipment Identity) number or a pin number for cellular phones. Further, each member may create an arbitrary User ID based on parameters set by the peer-to-peer group. The IMEI, user id and any other unique identity data (e.g., password) used for each member of a peer-to-peer group are entered into the Management Server 106 of the communication system 102, which transfers such information to the Database Server 104.

A subscriber who is a member of a peer-to-peer group will have an app downloaded onto his/her cellular phone once successfully registered. The registration would have taken place at a website (i.e., a communication portal) in communication with and/or under the control of the Management Server 106 of the communication system 102. During registration, the Management Server would have queried the subscriber if he/she has been invited to become a member of a peer-to-peer group. Upon confirming such an invitation, the subscriber will be given a list of peer-to-peer groups (appearing as links on the web page) in his/her area. The subscriber is assumed to know the name of the peer-to-peer group and the general username and password needed to enter the link registration page. If the list of links does not include the peer-to-peer group the subscriber wishes to join, the subscriber is given the opportunity to enter the name of the group in a pre-defined field provided by the Management Server 106. Upon entering the correct name (i.e., a name that exists in the Database Server 104 of the communication system 102), the subscriber is given the opportunity to enter the User ID and/or password of the peer-to-peer group. If successful, the subscriber is informed that his/her name (or pseudonym or a chosen name) has been added to the membership of the peer-to-peer group. Also, upon activation of the app downloaded onto the cellular phone of the subscriber, the name of the peer-to-peer group will be displayed amongst a list of system or user created public ZB radio voice/text chat groups available to the subscriber. Any subscriber who is a member of a listed peer-to-peer group (or any other peer-to-peer group) will have the names of those peer-to-peer groups appear in the list. A subscriber can then simply click on any name on the list of chat groups (including names of peer-to-peer groups) to gain access to that group as long as the subscriber is a member.

Peer-to-peer groups are subscriber created, but the communication may, at the request of a subscriber, create a peer-to-peer group. Upon completion of registration a new subscriber is given the opportunity to create one or more peer-to-peer groups. The subscriber is expected to have a name for each peer-to-peer group, a general User ID and a unique password for the group. In addition, each subsequent member of the group may be required to have their own unique password in addition to the general password. The system can also terminate a peer-to-peer group. A peer-to-peer group may also be terminated by a founder of the group or a member designated by the group to have such power. The name of this member is also stored in the Database Server 104 along with other information associated with the peer-to-peer group. Peer-to-peer groups may comprise only two members located anywhere in the world, but who can communicate with each other as long as they have activated their user equipment (typically a cellular phone) to listen for messages from the other member. In that sense, peer-to-peer consisting of two persons is similar to walkie-talkie operation except there are no geographical limits. When the Internet (or some other public or private worldwide communication network) is used as the medium for conveying voice/text information globally, the members can speak to each other virtually at any time from anywhere without having to use any telecommunication network or telephone system services.

2. System Created ZB Radio Voice/Text Chat Groups for on-Site Members

Upon completion of the registration process, a subscriber will be given an opportunity to become a member of one or more chat groups listed on the subscriber's communication device and/or listed on a page of the website which the subscriber is using to register. The subscriber can, at that time or at some later time, choose the various chat groups of which he/she wants to become a member. Many of the publicly available chat groups may not require membership other than being a subscriber to the communication system. As a subscriber travels in any local area and becomes physically located within the zones of a number of available ZB radio voice/text chat groups, the available chat groups will appear on the subscriber's cell phone as long as the app associated with the communication system of the present invention is activated by the subscriber. Any system created ZB radio voice/text chat groups will be for On-Site members. Many such chat groups will also be available for omnipresent members as well; those groups will be listed in a website of the communication system. Voice/text chat groups for omnipresent members can be located anywhere there is service being provided by the communication system. However, many such systems are advantageously zoned near landmarks, famous downtown centers, major interstate highways and/or tourist locations.

3. System Created ZB Radio Voice/Text Chat Groups that Include Omnipresent Members

Upon completion of the registration process, similar to the voice/text chat groups for on-site members, groups that allow omnipresent members will be listed and be available for membership to interested subscribers. Many of these groups will not require actual membership other than being a subscriber to the communication system of the present invention. These voice/text chat groups will be typically located in areas of high traffic (pedestrian and/or vehicular), and high interest locales such as major roadways or interstate highways, major transportation hubs such as airports, train stations, bus stations, major tourist attractions and/or landmarks, major naval ports and major cultural centers. Travelers on major interstate highways can join voice/text chat groups zoned at various segments of the highway and thus a traveler can broadcast a query to a chat group zoned in an area in which the traveler will be located in a few hours or a zone that may be several hundred miles away but on the same interstate highway. For example, travelers driving on the I-95 interstate highway on the eastern seaboard can broadcast queries to sections of the I-95 interstate to ascertain the current traffic, weather and other conditions of the highway at that location. The communication system may have chat groups defined by zones positioned, shaped and defined by the actual route of the I-95 interstate highway, say 3 miles on either side of the highway for the entire length of the highway. Thus, any vehicle traveling on I-95 will be located in some particular zone and will be able to broadcast and/or listen to chat broadcasts as it is traveling along the I95 corridor. Travelers may want to know the current conditions of the locale to which they are travelling and may believe that they can obtain the goings-on of a locale by speaking to the local population instead of relying on brochures, scripted descriptions, news reports and other reporting media.

4. Subscriber Created Groups for on-Site Members

Subscriber created ZB radio voice/text chat groups are similar in operation to system created voice/text chat groups as described above. The only difference is that the zone boundaries need to be defined by the subscriber at the time of registration. The boundaries can be defined by the subscriber identifying or specifying a specific zone center point (preferably in latitude and longitude coordinates), and then identifying the radius of the zone thus defining the entire zone. Zones can also defined by multiple coordinates (instead of a center coordinate) and the connections of the coordinates to each other result in the defined zone. The coordinates can be obtained from GPS devices. Subscribers can also use famous landmarks as points of references in describing their zones during registration and the communication system will accommodate them accordingly.

5. Subscriber Created ZB Radio Voice/Text Chat Groups for Omnipresent Members

Subscriber created ZB radio voice/text chat groups for omnipresent members are available as these sites are listed by the communication system and are available for membership to on-site and omnipresent members. These groups are formed in much the same manner as groups by the system or subscribers described above. The voice/text chat groups can be very valuable to travelers who want to get a feel for a particular location by speaking to individuals who live nearby and/or who are familiar with the particular zone in question.

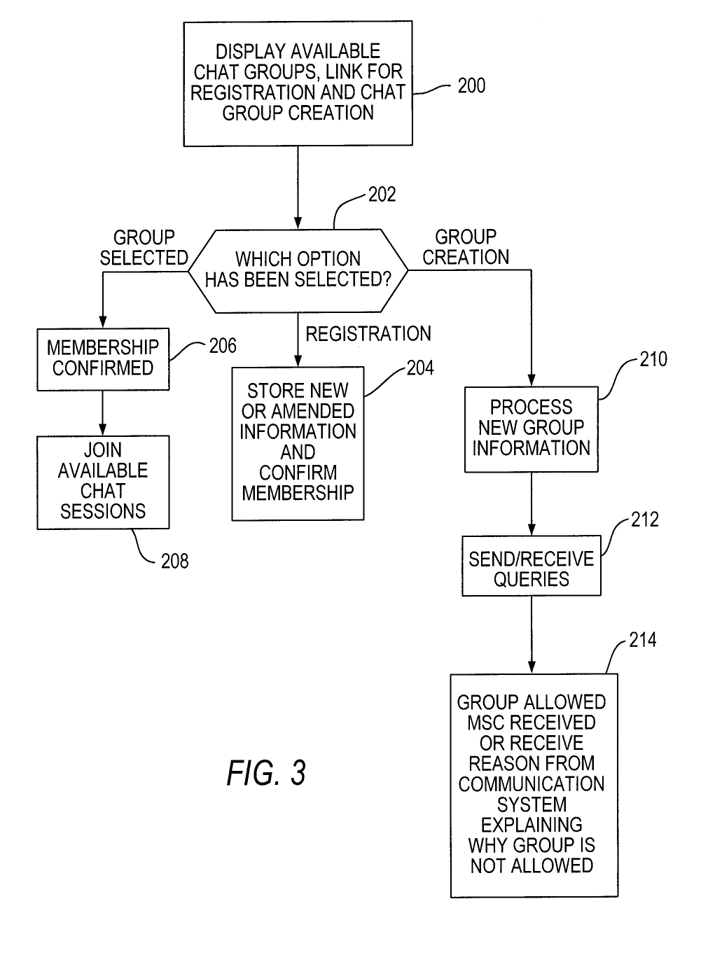

Referring now to FIG. 3, there is a shown a flow chart of the method of the present invention performed by a user equipment with the use of an app downloaded thereon. Initially, a user equipment accepts inputted registration information received from a user or the amendment of a user's registration information. Also, the user equipment is used for participation in ZB radio chat sessions in system and user created voice/text chat groups and in peer-to-peer voice/text chat groups. The user equipment can also be used to create new ZB radio voice/text chat groups. For the sake of explanation, the user equipment is a portable communication device such as a cellular phone onto which an app (application program) has been downloaded from the communication system of the present invention. The app allows the user equipment to communicate with the communication system to register, enter chat sessions, and/or create new voice/text chat groups.

In step 200, once the app is downloaded and activated, the user equipment displays (not shown) a list of available chat groups existing in the vicinity of the location of the user equipment and displays any peer-to-peer groups associated with the user equipment. Voice/text chat groups, which are not necessarily in the vicinity of the user equipment, but of which the user is an omnipresent member are also displayed. Also displayed is a link pointing to a site at which registration (or amendment to registration information) can be performed. Registration can also be performed via the Internet using the user equipment or any other Internet enabled device (e.g., laptop, tablet, or desktop). Further displayed is an option that allows new chat groups to be created. As with registration, a device other than the user equipment can also be used for creating new chat groups. A registered user can access his/her account via the Internet at a communication portal and create new chat groups, or amend registration information. Internet enabled devices other than mobile devices can also be used to enter into chat sessions if such devices have the proper voice/text transmitting and voice/text receiving hardware integrated therein. The information displayed on the user equipment was transmitted from the Management server 106 to the user equipment.

In step 202, the user equipment detects which option has been selected. If an existing voice/text chat group is selected (or a peer-to-peer group has been selected) the app allows a user to operate the user equipment in ‘push to talk fashion’. Selection is done through a touch screen of the user equipment. Also, the user equipment can be manipulated to increase its broadcast range. As the broadcast range is increased, new chat groups are automatically entered and, if a member of these new groups, a user equipment may be part of a plurality of voice/text chat groups simultaneously. In general, much of the chat sessions for user created and system created chat groups can be entered automatically by virtually any subscriber who is a member of an appropriate chat group. However, some voice/text chat groups (e.g., peer-to-peer groups) may require the member to enter his/her password in order to join chat sessions. As the broadcast range of the user equipment is increased and new voice/text chat groups are encountered, the user equipment will be allowed to join these groups as long as it is already a member of such groups; the communication system can compare the user equipment identity information to confirm that the user equipment is associated with a user who is already a member of the group. If not, the user may be requested to become a member depending on the membership requirements of the group.

In step 206, for each voice/text chat group in which the user wishes to enter, the membership of the user is confirmed through the user profile information, user authentication information and user equipment identity information already on file in Database Server 104 for that user and associated user equipment. In particular, user authentication information may be required by the communication system to be entered into the user equipment to confirm membership. For peer-to-peer groups or for groups in which the user and associated user equipment have omnipresent membership, the user equipment receives the entered user authentication information, user authentication information and user equipment identity information and transmits such information to the Management Server 106 of the communication system. The user equipment then receives a membership confirmation message from the communication system and displays same.

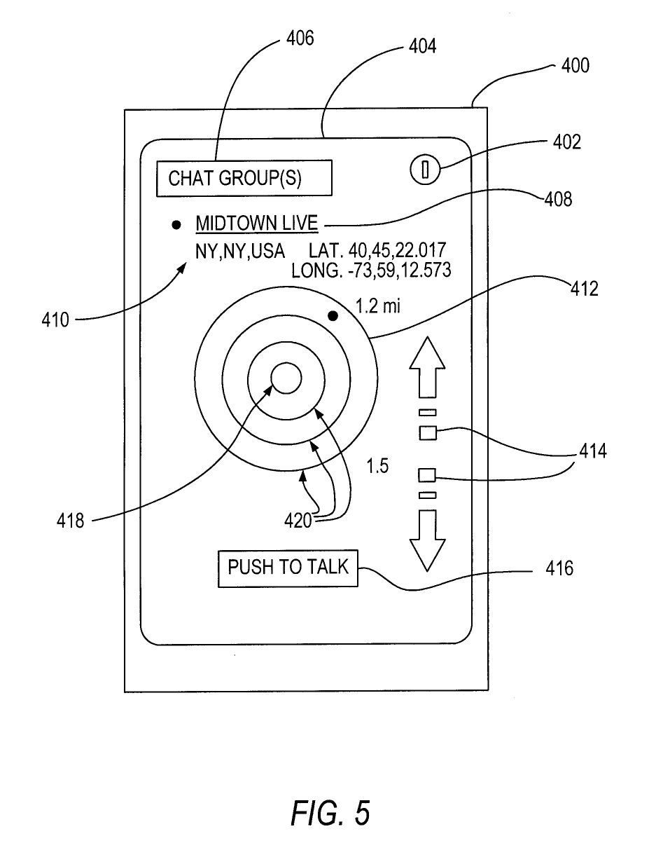

In step 208, the user is allowed to join any available ZB radio voice/text chat groups and any other ZB radio voice/text chat group of which the user is a member, but which are not necessarily nearby; these ZB radio voice/text non-local chat groups include peer-to-peer voice/text chat groups and/or ZB radio voice/text chat groups of which the user is an omnipresent member. In the following example, a user is located in midtown New York city (near world famous Time Square) and is about to select one ZB radio voice/text chat group from a list of ZB radio voice/text chat groups appearing on the display of the user equipment (e.g., a cellular smart phone). The user equipment then provides the graphics to allow push to talk operation in the voice/text group selected. One example of a graphics user interface (GUI) that can be displayed once a user enters a chat group is shown in FIG. 5.

FIG. 5 shows a cellular telephone 400 with screen 404. Screen 404 is a touch activated screen (i.e., a “touch screen”). The display will appear as such when the downloaded app from the communication system has been activated. Some of the graphics being displayed (e.g., graphic 414, 406 and 416) on the screen can be activated by ‘touching’ them. Graphic 402 is a on/off graphic which when touched de-activates the app. The “CHAT GROUPS” graphics 406 depicts the title of the list of chat groups being shown. In the example shown, only one chat group is on the list and the particular one chat group 408 is entitled “MIDTOWN LIVE” located in New York City near Times Square with GPS coordinates Latitude North 40° N 45′ 22.017″, Longitude 73° W 59′ 12.573″ representing the GPS coordinates of the group center point 418. A City and country location 410 is a standard part of the display. A reference map, 412 shows direction (northeast) and distance (1.2 miles) of user equipment (and presumably user) with respect to location of chat group reference point or chat group center point 418. A range selector arrow (or increase/decrease arrow) 414 is available for the user to select the range within which the user wishes to broadcast. Note, the terms “increase/decrease arrow” and “range selector” are used interchangeably. In the example shown, the range is set at 1.5 miles as (and thus the largest distance searched is 1.5 miles radius from the geographic center 418 of current ZB radio voice/text chat group. If the user equipment 400 were not already in a chat group, then the actual location of the user equipment would be used as the center reference point instead of the chat group center or reference point 418. As the range arrow (or range selector) 414 is manipulated to increase or decrease the range of broadcast, chat groups falling within the new range are either added or removed accordingly. The list of displayed chat groups names changes accordingly. In FIG. 5, the range is currently set at 1.5 miles from the center of the chat group MIDTOWN LIVE and, in this example, no other chat group exists within this 1.5 mile radius other than the one listed. It will be readily understood that under different circumstances, the list of ZB radio chat groups can comprise a plurality of chat groups, each having the information associated with them displayed as shown for the MIDTOWN LIVE ZB radio voice/text chat group.

There may be circumstances in which two or more chat groups have overlapping zones and where a user may be a member of the two or more chat groups. However, the system of the present invention will, upon a user entering a chat group, send a message to such user to select one of several chat groups of which the user is a member. As a result, the user may be located in an area that overlaps two or more chat group, but the user will receive broadcasts from the chat group he/she has selected in response to the message sent by the communication system. In this manner, the operation of the communication system is simplified and the user can control which chat group in which he/she wants to participate.

Push to Talk bar 416 allows a user to broadcast a voice/text message in accordance with a protocol of push-to-talk operation. In one embodiment, when a user wishes to broadcast a voice/text message, he/she touches ‘push to talk’ bar 416. At that point, all current active members of the chat group are kept from broadcasting and once this is done by the communication system, a short burst tone is generated after which the user is given N seconds (where N is an integer equal to 1 or greater; but typically N=5) to start his/her broadcast. If the user does not start his/her broadcast within the allotted N seconds, the broadcast privilege is removed by the system and the user must touch the bar 416 again to gain broadcast capability once again. During a broadcast by any user, any gap of no voice/text transmissions equaling J seconds or greater will signify end of transmission by the user; J is an integer equal to 1 or greater. Typically J=5 seconds. Alternatively, the user can touch a graphics in the shape or appearance of a button (not shown; this button appears upon the start of the broadcast and will disappear after a J second period of no transmission) to signal end of transmission. The length of each broadcast is kept within a limit of K seconds (K is an integer equal to 1 or greater, e.g., K=20 seconds), which is set by the communication system. However, users can request for K>20 sec. at the time of registration and, depending on the chat group for which a user is registering, the communication system may grant a broadcast time of K>20 seconds. The broadcast is received by every member of the group who has activated his/her app downloaded onto the user equipment (e.g., cellular telephone 400 of FIG. 5) currently geographically located within the boundaries of the chat group and is currently listening for broadcasts. The actual zone of the MIDTOWN LIVE ZB radio voice/text chat group is defined by all points 1.5 miles from the center point (i.e., a circular shape zone). The boundary 412 of the chat group is shown as 1.5 miles near the up/down arrow 414. As the range selector 414 is touched to either increase or decrease the range, that display of the range as it is changing is shown. The actual boundary 412 of the chat group may be shown in a different color from the inner ranges 420 or may be blinking to indicate to the user that this is the actual border of the chat group in which the user/user equipment is broadcasting or is receiving broadcasts.

Any member currently active in the group and listening to broadcasts can broadcast his/her own messages as per the protocol discussed above or as per any accepted protocol. At the end of a broadcast, the first user that presses the push to talk button (or at least the first user detected by the system to do so) will be allowed to broadcast as described above. If two or more users attempt to broadcast at the same time or approximately at the same time (i.e., within L seconds of each other where L is a real number equal to 3 or less), then the communication system will select one of the users in accordance with arbitrary parameters set by the communication system. For example, if three users attempt to broadcast at the same time or within say 1.8 seconds of each other, the communication system may select the user whose current location (or location at time of request) is closest to the geographical center (e.g., location 418 in FIG. 5) of the ZB radio voice/text chat group; thus, in this example, the arbitrary system parameter is shortest distance to the center of ZB radio voice/text chat group. The communication system, as discussed supra, knows the location of each participating member from their GPS coordinates or triangulation coordinates or both.

Returning now to step 202, if the option selected on the user equipment (e.g., cellular telephone 400 of FIG. 5) is to register or amend registration, the method of the present invention moves to step 204.

In step 204, the user equipment displays a form (not shown) with various fields in which user profile information, user authentication information, terms of the subscription agreement between user and owner/controlling entity of the communication system and user equipment identity information are entered for the first time, or amended by the user and are then transmitted to the communication system by the user equipment. The communication system then processes and confirms the received information. Further, the user can select the various ZB radio chat groups of which he/she wants to be a member. It will be readily understood that the registration can also be done at a communication portal controlled by and in communication with the Management Server (e.g., server 106 of FIG. 1) of the communication system of the present invention; the communication portal can be a website in communication with and controlled by the Management Server or it can be a phone number (e.g., an 800 number) serviced by agents of the communication system of the present invention. Once all of the information has been entered and a payment agreement has been entered into between the now subscriber of the communication system and his/her membership to any group in which he/she is currently located is confirmed by the communication system by sending a confirming message to the user equipment and/or to an email address of the subscriber.

Returning again to step 202, if the option selected by the user is group creation, the method of the present invention moves to step 210.

In step 210, the user equipment provides forms (not shown) having various fields for the user to enter the name of the new group, the geographical center of the new group and its boundaries. The user can totally define the zone of the new group by providing the coordinates of the group's geographical center and its radius defining a circular zone. Alternatively, the user can provide or enter the coordinates of at least three geographical points, which when connected to each other define a zone for the chat group. The user may enter the “theme” of the chat group, which is a description of the main goals of the group, the raison d'être of the group and/or the main topic to be discussed in the group at all times. In step 212 a user in the process of creating a new chat group may be required to undergo a question and answer session by the communication system via the user equipment to confirm that he/she will abide by and comply with the rules and regulations of proper behavior of group members. During such a session, the user equipment will activate its microphone and keyboard for voice/text communications between it and the communication system (e.g., Management server of the communication system). In step 214, the communication system through a transmitted message to the user equipment will further make the potential user/creator of a new group understand that the system is owned and controlled by an owner/controlling entity who can decide unilaterally, based on its stated policies, whether to accept a new group and allow its creation or not allow the creation of a new group and the reasons why it, the communication system, has arrived to such a decision.

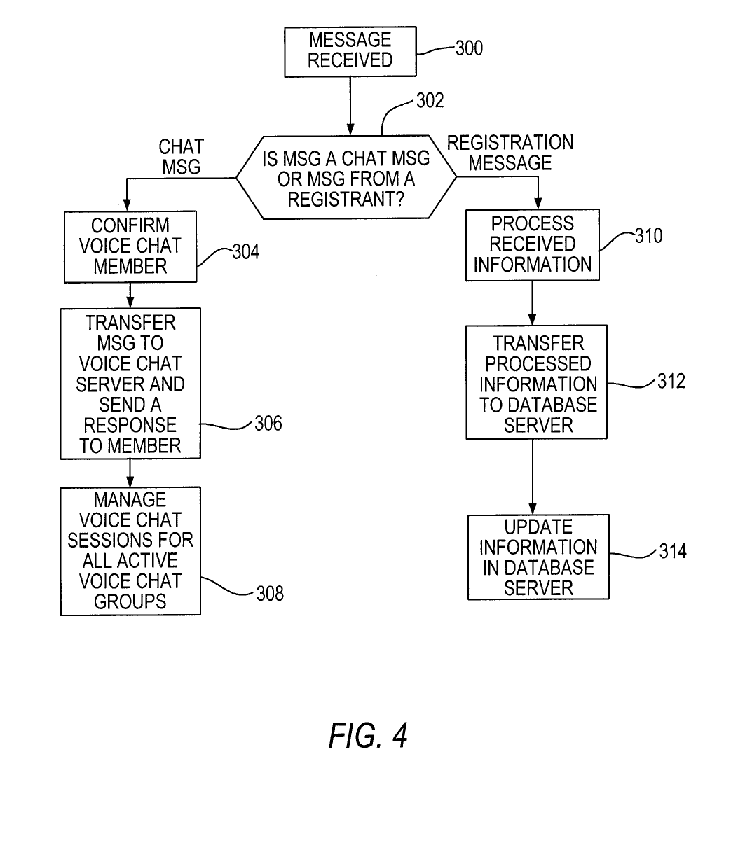

Referring now to FIG. 4, there is shown the method of the operation of the communication system 102 (see FIG. 1) as it processes broadcast information and transmits the broadcasts or as it processes received registration information including information relating to creating a chat group. In step 300, the communication system receives a message. With respect to the embodiment shown in FIG. 1, Management server 106 receives a message from a subscriber or a potential subscriber via communication link 118.

In step 302, the communication system, and in particular, Management server 106 determines whether the received message is a chat message, a request message from a potential subscriber desiring to register, a subscriber desiring to amend his/her registration information or a subscriber desiring to create a chat group. If the message is from a potential registrant or a registrant desiring to amend his/her registration information or create a chat group, the method of the present invention moves to step 310.

In step 310, the communication system sends queries and/or various forms for the user to complete. The communication system then processes the received information to make sure all questions and all information have been properly answered and provided by the user. Once the received information is processed, in step 312, the communication system transfers the information to Database server 104 via communication link 114. It will be readily understood that the message received by the communication system was transmitted from a user equipment (e.g., cellular phone) or from a communication portal that allows the user to amend or enter for the first time his/her registration information or provide information needed to create a new chat group. Prior to this allowance, the user would at some time have been required to create an account using a password and user name at the site representing the communication portal. The received registration information is processed by the Management server. In step 314, the communication system accordingly updates information regarding a user and his/her memberships to chat groups based on the latest amendments received from the user. The updated information is stored in the Database server 104.

Returning to step 302, if the communication system that the received message is a chat message, the method of the present invention moves to step 304 to confirm the identity of the user equipment and the user and to confirm whether the user is indeed a subscriber and moreover a member of the chat group from which he/she is broadcasting. The Management server 106 confirms all of this data by reviewing the information stored in the Database server for the particular user equipment and also the GPS coordinates (or triangulation coordinates) of the user equipment to confirm the actual location of the user equipment.

In step 306, the voice/text chat broadcast is transferred to the voice/text chat server 108 via communication link 116 by the Management server 106. The Management server 106 controls the voice/text chat server 108 to transmit the broadcast to all members currently listening and located within the zone of the chat group to which the broadcaster belongs. The Management server 106 may itself send a response to the broadcasting member or have the voice/text chat server 108 send a message appearing on the display of the member's user equipment confirming to the user that his/her message was successfully broadcast.

In step 308, the Management server 106 through control of the voice/text chat server 108 will manage the various broadcasts of active chat group members for various chat group sessions simultaneously. Each broadcast will be transmitted simultaneously to each member of a chat group.

Once a chat group is created by a user and accepted by the communication system, it may have various characteristics and features associated with it, some of which are user created while others are system created. One system created feature of chat groups is the ability of the police and other emergency authorities such as the Fire Department and EMS (Emergency Medical Services) to monitor ZB based radio chats for broadcasts from people in distress. The advantage of such communications allows the police or other authorities to quickly arrive to the specific location from which the distress broadcast was made or at the location of the user and the user equipment. This is because, as explained supra, each user, and in particular, each user equipment has a GPS or triangulation coordinates (or coordinates obtained from a processing of both GPS and triangulation) associated with it. The GPS and/or triangulation coordinates are continuously or constantly being transmitted to the communication system from various user equipment as the user and user equipment move from place to place.

Another system created feature is that subscribers are by default members of many system created groups such as travelers travelling along major interstate highways. The communication system, knowing the coordinates of the interstate highway, will make subscribers traveling on the highway be automatically members of these Interstate highway groups. Accidents, and/or emergency situations that occur on such highways will be quickly attended to by the authorities because they will know the exact location of the emergency based on broadcasts made by a member of those system created chat groups. Travelers on a highway are moving at relatively high speeds compared to members located in a specific zone within a city or within a specific area where the members are, for the most part, walking. Thus, for members moving at relatively high speeds, the communication system of the present invention still maintains an updated log of each member's location coordinates. The communication system will calculate the speed of all members of a chat group and if it determines that a member's speed is above a certain threshold (arbitrarily defined by the system, say for example, the threshold is 5 miles per hour), the system increases the frequency of monitoring such members. When the speed of the member decreases below the set threshold, the frequency of monitoring is decreased accordingly. The frequency of monitoring refers the amount of times the system calculates the location of a member based on GPS coordinates, triangulation coordinates or a combination thereof.

Depending on the speed of a subscriber the system may increase or decrease the frequency of monitoring. Also, depending on the speed of a subscriber the system will make available more or less voice/text chat groups to such a subscriber. When a subscriber's speed has been calculated to be that of a walking person, the system may update the location coordinates of such a subscriber every 15 seconds. For a driving subscriber the updating of the subscriber's information and in particular his/her location, the updating may occur every 5 seconds for example. If a subscriber is driving on a major interstate highway, for example, because of the member's speed, it would not be practical to give the user access to groups that the subscriber will be passing through fairly quickly. However, if the speed of a subscriber drops below, say 2 mph, it will be assumed by the communication system that the subscriber is walking and thus it makes sense to make any voice/text chat groups in the vicinity available to the subscriber. The subscriber may be able to enter the system created groups and other groups whose membership requirements are relatively liberal. For situations where a subscriber is located in overlapping zones of different groups, the communication system will request the subscriber to select one group from the overlapping chat groups as discussed earlier.

The user equipment onto which an app is downloaded from the system gathers various data about its location and other information and transfers such data a certain number of times per a system defined period. In the event that the user equipment loses communication with the communication system, (e.g., system loses cell coverage) it will have the capability to continue to gather location data and other data and transfer such data to the communication system upon regaining communications with the system. Each time the user equipment gains connection to the communication system, it will transfer all collected data to the communication system. Also, the user equipment will have the capability to calculate location coordinates from either GPS or triangular coordinates or a combination thereof; in the event GPS coordinates are not available, the user equipment as controlled by the downloaded app will send triangulation coordinates to the communication system. The activation of the app typically means continuous transmission of location data other information from the user equipment to the communication system. As such, the app will monitor the battery level of the user equipment and when the battery level drops below a system defined threshold, the user equipment is programmed to transmit data less frequently to preserve battery energy.

As shown in FIG. 1, the communication system 102 conveys (i.e., transmits and/or receives) information to a user equipment 134 (shown as a cellular telephone in FIG. 1) via the Internet 120. The user equipment 134 is thus an IP (Internet Protocol) telephone meaning that it is able to send and receive information via the Internet in accordance with the Internet protocol for transmitting and/or receiving voice/text. If the user equipment 134 is not an IP phone (i.e., cannot use the Internet), the cellular communication system (part of which is shown in FIG. 1 as cell sites 128, 130 and 132 and MSC 126 and Triangulation Data server 136 and associated communication links) will transfer its triangulation coordinates for the location of user equipment 134 to the communication system to allow for the implementation of ZB radio voice/text chats.

Because the intermediate communication network (i.e., the communication network standing between the communication system of the present invention and the cellular communication network) cannot be the Internet, another pathway is to be used to allow communications between the communication system 102 and the cellular communication network. The intermediate communication network replacing the Internet may be the PSTN (Public Switched Telephone Network) or a global public or private network other than the Internet. Broadcast messages and other information can thus use such a network as the intermediate network to replace the Internet. How a subscriber communicates with the communication system of the present invention necessarily is different than if the Internet were the intermediate communication network.

Further, in the case where the user equipment is not an IP telephone and the intermediate communication network is the PSTN, the user can dial a phone number being used as a communication portal by the communication system. Upon dialing the phone number using a non-IP telephone, the subscriber's telephone number will be recognized by the communication system through a caller id feature and based on the registration information and other information already stored in the system, the subscriber will be allowed by the communication system to enter into an available chat room if the subscriber is a member of the zone based chat group in which the subscriber is currently located. Once entered into the chat room, the subscriber will communicate with the system in a different manner than if he/she had an IP phone.

The communication system will establish an IVR (Interactive Voice Response) system, which replaces up/down arrow 414 shown in FIG. 5 for an IP phone. With a non-IP phone, the user may request for the ability to change the range of his/her zone. The system will respond by instructing the user on how to change the range. For example the system might give the user the ability to increase or decrease the range and also the ability to select the increment of increase or decrease. The system will then identify one key, say the “1” button as the button for incrementing the range and the “2” as the button for decreasing the range. Each time the user presses the “1” or “2” button, the system will tell the user the current range. For example, suppose the increments were set at 0.5 miles and thus each time the “1” button is pressed the range increases by 0.5 miles. Therefore, initially the user pressed the “1” button 10 times with each time the system vocally discloses the range. After the user had pressed the “1” button for the 10^{th} time, the communication system will send a voice/text message stating “Your range is now 5.0 miles, please indicate termination of selection of range by pressing the “0” key. After each time the “1” button is pressed, the same message is transmitted to the user with the only distinction being the range number. Once the desired range is reached, the subscriber can then press the “3” button to indicate to the system that he/she no longer wants to change the range. At some time later, the subscriber can repeatedly press the “2” button to decrease the range to a desired amount. A subscriber using an non-IP phone can also have a peer-to-peer chat with another subscriber by entering the proper password or user id when prompted. The subscriber can state the password into a voice recognition software established by the communication system and the system will determine if the right password was voiced by the subscriber and allow or not allow the peer-to-peer chat accordingly.

For the communication system depicted in FIG. 1, the communication network to which the subscriber belongs is a cellular communication network. For example the cellular communication network can be a TDMA (Time Division Multiple Access) or a CDMA (Code Division Multiple Access) network. In both cases the user equipment is an IP cellular telephone. The cellular communication network can also be an analog network. Generally, the user equipment can be IP telephone or non-IP telephones as discussed earlier.

While various aspects of the present invention have been described above, it should be understood that they have been presented by way of example and not limitation. It will be apparent to persons skilled in the relevant art(s) that various changes in form and detail can be made therein without departing from the spirit and scope of the present invention. Thus, the present invention should not be limited by any of the above described exemplary aspects, but should be defined only in accordance with the following claims and their equivalents.

In addition, it should be understood that the figures in the attachments, which highlight the structure, methodology, functionality and advantages of the present invention, are presented for example purposes only. The present invention is sufficiently flexible and configurable, such that it may be implemented in ways other than that shown in the accompanying figures.

What is claimed is:

1. A geographic zone based communication system comprising:
a Management Server in communication with at least one communication network;
a Database Server in communication with the Management server where the Database server contains received data and/or system generated data comprising user equipment geographic location data and user equipment identity information for at least two user equipment of the at least once communication network; and
a Voice/Text Chat Server in communication with and controlled by the Management Server to broadcast messages to user equipment of subscribers the communication system while the subscribers are located within a zone based chat group defined from one of the user equipment geographic location data and the user equipment identity information received from the user equipment of the subscribers.

2. The geographic zone based communication system of claim 1 where the Database Server further contains user profile information and user authentication information.

3. The geographic zone based communication system of claim 1 where the Voice/Text Chat Server is controlled by the Management Server to broadcast voice and/or text messages from any member of a chat group to listening on-site members and/or omnipresent members of the chat group.

4. The geographic zone based communication system of claim 1 where the Management Server verifies a password entered by a member and thus can identity the member from user authentication information and user profile information stored in the Database Server.

5. The geographic zone based communication system of claim 1 where the Management Server controls communication portals in communication therewith and receives user profile information, user equipment identity information and any other pertinent information during said communications.

6. The geographic zone based communication system of claim 1 where the Management Server receives messages intended for broadcast from members and identifies the members based on user profile information, user authentication information, and user equipment identity information.

7. The geographic zone based communication system of claim 1 where the at least one communication network comprises one or more digital communication networks.

8. The geographic zone based communication system of claim 1 where the at least one communication network is a Public Switched Telephone Network (PSTN).

9. The geographic zone based communication system of claim 7 where the one or more digital communication networks comprise a cellular communication network coupled to the Internet.

10. The communication system of claim 9 where the cellular communication network is a TDMA network.

11. The communication system of the claim 9 where the cellular communication network is a CDMA network.

12. The geographic zone based communication system of claim 9 where the user equipment are cellular telephones, which form part of the zone based chat group defined by the communication system.

13. The geographic zone based communication system of claim 12 where the user equipment geographic location data comprise GPS location data of the cellular phones.

14. The geographic zone based communication system of claim 12 where the user equipment location data comprise cell site triangulation location data from the cellular communication network.

15. The geographic zone based communication system of claim 12 where the user equipment location data comprise cell site triangulation data from the cellular communication network and GPS location data from the cellular telephones.

16. The geographic zone based communication system of claim 12 where a cellular phone located outside of a zone based chat group is able to convey voice/text communication signals to the zone based chat group.

17. The geographic zone based communication system of claim 12 where the zone based chat group comprises cellular phones traveling on a particular section of an interstate highway.

18. The geographic zone based communication system of claim 9 where the at least two user equipment are at least two cellular telephones, which form part of a zone based chat group defined by one of the cellular phones.

19. The geographic zone based communication system of claim 18 where the user equipment geographic location data comprise GPS location data of the cellular phones.

20. The geographic zone based communication system of claim 18 where the user equipment location data comprise cell site triangulation location data from the cellular communication network.

21. The geographic zone based communication system of claim 18 where the user equipment location data comprise cell site triangulation data from the cellular communication network and GPS location data from the cellular telephones.

22. The geographic zone based communication system of claim 18 where a cellular telephone located outside of the zone based chat group is able to convey voice communication signals to the zone based chat group.

23. The geographic zone based communication system of claim 18 where a cellular telephone located outside of the zone based chat group is able to convey text communication signals to the zone based chat group.

24. The geographic zone based communication system of claim 18 where a cellular telephone located outside of the zone based chat group is able to convey voice and/or text communication signals to the zone based chat group.

25. The geographic zone based communication system of claim 18 where the zone based chat group comprises cellular phones traveling on a particular section of an interstate highway.

26. A method for broadcasting information to a ZB radio chat group of a communication system by a user equipment, the method comprises:
receiving, by the user equipment, an app from the communication system;
displaying, by the user equipment, available ZB radio chat groups and options relating to user registration and chat group operation; and
performing, by the user equipment, one of joining a chat group, allowing user registration, and allowing creation of chat group.

27. the method of claim 26 where a displayed option is a range selector allowing an operator of the user equipment to select a broadcast range.

28. The method of claim 26 where the user equipment receives GPS data, which is used to create a zone based chat group.

29. The method of claim 26 where the user equipment receives user profile information, user authentication information and user equipment identity information and transmits such information to the communication system.

30. The method of claim 26 where the user equipment is an IP cellular telephone that is part of a TDMA cellular communication network.

31. The method of claim 26 where the user equipment is an IP cellular telephone that is part of a CDMA cellular communication network.

32. The method of claim 26 where the chat group created is one of a peer-to-peer group, a system created chat group for on-site members, a user created chat group for on-site members, a system created chat group for omnipresent members and a user created chat group for omnipresent members.

33. The method of claim 26 where one of the displayed options is a ‘push to talk’ bar allowing a user of the user equipment to broadcast in ‘push to talk’ fashion.

34. The method of claim 26 where the user equipment joins a chat group and confirms membership of the user from a confirmation message received by the user equipment from a Management server of the communication system.

35. The method of claim 26 where the user equipment joins a chat group and transmits a voice/text message to the communication system which broadcasts said voice/text message to the chat group.

36. The method of claim 26 where the user equipment joins a chat group and transmits a text message to the communication system which broadcasts said text message to the chat group.

37. The method of claim 36 where the communication system converts the text message to a synthesized voice/text message and broadcasts the synthesized voice/text message to the chat group.

38. A method for operating a geographic zone based chat system by a communication system, the method comprises:
receiving a message;
determining whether the received message is a chat message or a request for registration message; and
performing one of updating information stored in a database server of the communication system based on received registration information and managing voice/text chat sessions for all active voice/text chat groups.

39. The method of claim 38 where the message is received by a Management server of the communication system.

40. The method of claim 38 where managing voice/text chat sessions comprises a Management server of the communication system confirming that the received message is from a registered user and upon said confirmation the Management server transfers the received message to a Voice/text chat server of the communication system.

41. The method of claim 38 where a Management server of the communication system determines whether the received message is a chat message or a request for registration message.

42. The method of claim 38 where the message is a request for registration and a Management server of the communication system processes the information and transfers the information to a Database server of the communication system.

43. The method of claim 38 where the received information is a request for registration and the received message is used by the communication system to update information in a Database server of the communication system.

44. The method of claim 38 where, based on received user equipment geographic location data, the communication system continuously monitors, during certain intervals, physical locations of user equipment of members of chat groups.

45. The method of claim 44 where the monitoring is done at, one of, regular intervals and irregular intervals.

46. The method of claim 38 where, based on received user equipment identity information, the communication system monitors identities of user equipment of every subscriber in a chat group to determine if a subscriber is a member of the chat group.

47. The method of claim 46 where the member is one of on-site member and omnipresent member.

48. The method of claim 38 where the communication allocates M channels to each chat group where M is an integer equal to 1 or greater.

49. The method of claim 48 where different channels may cover different portions of zones of a chat group.

50. The method of claim 48 where different channels may cover an entire zone of a chat group.

51. The method of claim 38 where the message is received by a Management Server which determines that said message is a chat message after having verified that the message is from a member of a chat group permitted by the communication system to broadcast messages as per a protocol established by the communication system.
